(19) United States
(12) Patent Application Publication
(10) Pub. No.: US 2006/0271419 A1
(43) Pub. Date: Nov. 30, 2006

(54) Method and system for prioritizing meeting attendees

(76) Inventor: Patrick O'Sullivan, Ballsbridge (IE)

Correspondence Address: LOTUS AND RATIONAL SOFTWARE;STEUBING MCGUINNESS, 125 NAGOG PARK, ACTON, MA, 01720, US

(21) Appl. No.: 11/141,171

(22) Filed: May 31, 2005

(51) Int. Cl. G05B 19/418

(52) U.S. Cl. 705/8

(57) ABSTRACT

A system for prioritizing meeting attendees based on a scheduling user's perspective in an event scheduling system. The system provides a user interface for a scheduling user that enables them to prioritize individual prospective attendees, or groups of prospective attendees, in a way allows for easier evaluation by the scheduling user of a greater number of potential event times for a desired event, in situations where it may not be possible to establish an acceptable event time across all prospective attendees. The scheduling user can indicate a number N of priority levels, and the disclosed system operates to supply prospective event times relevant to each priority. Accordingly, where a scheduling user has assigned prospective attendees to priorities 1 through N, where priority 1 is the highest, the disclosed system would respond by simultaneously presenting to the scheduling user with N sets of prospective event times corresponding to the assigned priorities. Specifically, a first set of prospective event times would be presented that satisfy the availability constraints of all prospective attendees of priority 1, a second set of prospective event times would be presented that satisfy the availability constraints of all attendees of priorities 1 and 2, a third set of prospective event times would be presented that satisfy the availability constraints of all prospective attendees of priorities 1, 2 and 3, and so on through a set of prospective event times that satisfy the availability constraints of all prospective attendees of priorities 1 through N.

### FIELD OF THE INVENTION

The present invention relates generally to electronic calendaring and scheduling software, and more specifically to a method and system for prioritizing meeting attendees.

### BACKGROUND OF THE INVENTION

As it is generally known, electronic calendaring and scheduling software applications enable a scheduling user to schedule a calendar event involving multiple attendees, such as a meeting, presentation, teleconference, videoconference, or the like. Examples of existing systems in this area include the Lotus Notes® and Lotus Organizer® systems provided by IBM®, and others.

While existing systems have provided significant functionality to their users, it is still often difficult to find an event time that is suitable to all attendees. This is especially true for events involving large numbers of attendees. Moreover, in companies having geographically distributed employees, the scheduling challenge may be compounded by the need to schedule meeting times across multiple time zones. As a result, meetings and other events must sometimes be significantly delayed beyond what would be otherwise desirable, in order to fully accommodate the individual schedules of large numbers of attendees.

Some existing systems have attempted to address these challenges by assigning weights to prospective attendees based on their availability. Attendees are then automatically eliminated from scheduling consideration based on lowest availability time, or on a “best fit” algorithm. However, existing systems have not yet sufficiently explored the significant benefits that can be derived for a scheduling user when prospective attendees can be individually or collectively weighted against one another based on the scheduling user's perspective of attendee attendance priority.

Another shortcoming of some existing systems is that they sometimes couple the TO:, CC:, and BCC: electronic mail (“email”) fields to attendee priority levels. In such a case, an event scheduling user may be constrained to selecting from meeting times based on the assumption that, for example, all users listed in the TO: field of an email event notification are required attendees, all users listed in the CC: field of the notification are optional attendees, and all users listed in the BCC: field are being copied just for their information (“FYI”). This prevents the scheduling user from selecting possible event times that are determined based on considering some of the users in the TO: field of the notification as having a higher priority than others, considering some users in the CC: or BCC: fields as having higher priority than some users in the TO: field, and so on. Moreover, the impression made by email event notifications is that all users listed in the TO: field are of relatively higher priority to those listed in the other fields. This may motivate a scheduling user to list all attendees within the TO: field, thus potentially preventing generation of possible event times that consider different attendees as having different priorities with regard to the event being scheduled.

For the reasons stated above and others, it would be desirable to have a new system for prioritizing meeting attendees that effectively facilitates convenient prioritization of prospective attendees based on a scheduling user's perspective of attendee priority with regard to a specific event being scheduled, and independent of how attendees are listed in email event notifications.

### SUMMARY OF THE INVENTION

To address the above described shortcomings of the prior art and others, a method and system are disclosed for prioritizing attendees in an event scheduling system, based on a scheduling user's perspective of attendee priority. The disclosed system enables a scheduling user to conveniently prioritize attendees in order to improve the probability of success with regard to scheduling a calendar event. The scheduling user is provided with a user interface through which they can prioritize individual attendees, or groups of prospective attendees. An attendee of a lesser priority can be filtered out of the event scheduling process as indicated by the scheduling user, thereby reducing the challenge of finding an event time acceptable to relatively higher priority attendees. As a result, the disclosed system enables scheduling of more timely and effective meetings, and reduces the challenge of scheduling events across multiple attendees and time zones for a scheduling user.

The disclosed system operates to provide a visual capability in a user interface for a scheduling user that enables fine grained prioritization of individual attendees, or groups of attendees, to allow determination of a relatively larger number of potential event times for a desired event. The disclosed system may be embodied to allow such attendee prioritization in situations where it is not be possible to establish a sufficient range of event times that are acceptable across all invitees. The disclosed system enables a scheduling user to indicate a number of attendee priority levels, where the number N of priority levels used for a given event may be user specific configuration parameter, or supplied on a per event basis. As a result of the user supplied prioritization of prospective attendees, the disclosed system operates to supply possible event times relevant to each priority indicated by the scheduling user. Accordingly, where a scheduling user has assigned prospective attendees to attendee priorities 1 through N, the disclosed system would respond by simultaneously presenting to the scheduling user N sets of prospective event times corresponding to the assigned priorities. Specifically, a first set of prospective event times would be presented that satisfy the availability constraints of all prospective attendees of priority 1, a second set of prospective event times would be presented that satisfy the availability constraints of all attendees of priorities 1 and 2, a third set of prospective event times would be presented that satisfy the availability constraints of all prospective attendees of priorities 1, 2 and 3, and so on through a set of prospective event times that satisfy the availability constraints of all prospective attendees of priorities 1 through N.

The disclosed system may further be embodied such that designations of which field a user is listed in for purposes of an email event notification is decoupled from that users priority. Accordingly, a user may be indicated for inclusion in any of the email fields TO:, CC:, BCC:, or the like, may be considered as having a relatively higher or lower priority with respect to any other user contained in any of those fields in the event notification.

Thus there is disclosed a new system for prioritizing meeting attendees that effectively facilitates convenient prioritization of prospective attendees based on a scheduling user's perspective of attendee priority with regard to the event being scheduled, and that can decouple priorities of event attendees from their positions within email destination address fields of an event notification message.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram illustrating hardware and software components in an illustrative embodiment;

FIG. 2 is a flow chart illustrating steps performed in an illustrative embodiment;

FIG. 3 is a simplified screen shot of a user interface for event scheduling provided by an illustrative embodiment;

FIG. 4 is a simplified screen shot of a user interface for prioritizing invitees provided by an illustrative embodiment; and

FIG. 5 is a simplified screen shot of a user interface for presenting possible meeting times based on user specified attendee priorities.

### DETAILED DESCRIPTION OF EXEMPLARY EMBODIMENTS

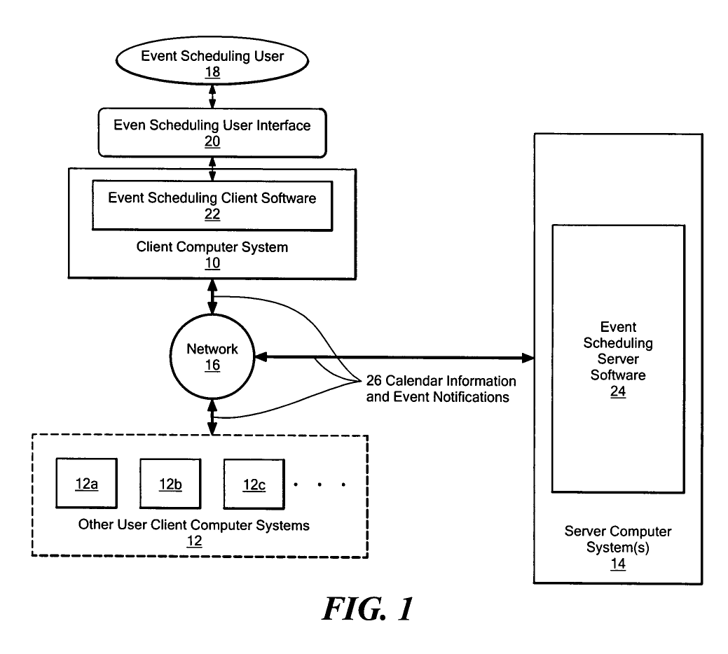

As shown in FIG. 1, in an embodiment of the disclosed system, a number of software components execute on various computer systems, shown for purposes of illustration in FIG. 1 including a client computer system 10 and other client computer systems 12, shown including a number of client computer systems 12a, 12b, 12c, etc., as well as one or more server computer systems 14. The client computer systems 10 and 12, and server computer system(s) 14 may, for example, each include at least one processor, program storage, such as memory, for storing program code executable on the processor, and one or more input/output devices and/or interfaces, such as data communication and/or peripheral devices and/or interfaces. The client computer systems 10 and 12 and server computer system(s) 14 are communicably connected by a data communication network 16, such as a Local Area Network (LAN), the Internet, or the like, which may also be connected to a number of other client and/or server computer systems. The client computer systems 10 and 12 and server computer system(s) 14 may further include appropriate operating system software.

As further shown in FIG. 1, an event scheduling user 18 is provided with an event scheduling user interface 20 by event scheduling client software 22 executing on the client computer system 10. The event scheduling user interface 20 may be provided through a graphical user interface (GUI) provided by the client computer system 10 to the scheduling user 18. The event scheduling client software 22 may be embodied through or as part of a rich client application platform providing access to variety of application functionalities, through or as part of a Web browser application program or the like, or in some other specific manner. In one embodiment, the event scheduling client software 22 operates in cooperation with the event scheduling server software 24 to provide the disclosed system, but those skilled in the art will recognize that the disclosed system is not limited to such a client-server implementation. Alternatively, the disclosed system may operate in a peer to peer environment, or in any other appropriate application configuration.

During operation of the embodiment shown in FIG. 1, calendar information and event notifications 26 are communicated between the client computer systems 10 and 12 and server computer system 24. For example, calendar information regarding users of the client computer systems 10 and 12 indicating available or free time of users associated with the client computer systems 10 and 12 may be collected by the event scheduling server software 24. The event scheduling user 18 uses the event scheduling interface 20 to define event attendees, and to determine possible event times based on availability of those event attendees. After determination and selection of a desired time for a given event, event notifications such as email messages are conveyed to ones of the client computer systems 10 and 12 in order to notify event attendees, for example by way of the Simple Mail Transfer Protocol (SMTP). As further described below, the event scheduling client software 22 and event scheduling server software 24 enable the event scheduling user, through the event scheduling user interface 20, to conveniently and effectively determine a desirable event time based on attendee priorities of the event scheduling user 18.

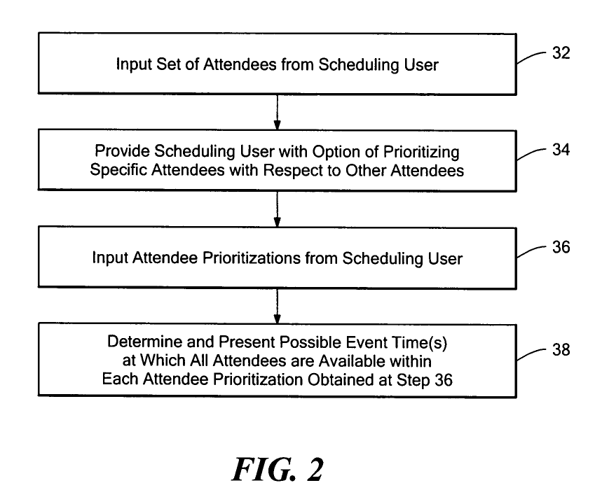

FIG. 2 is a flow chart illustrating steps performed by an embodiment of the disclosed system to enable an event scheduling user to find a desirable event time for a group of event attendees, based on the relative attendee priorities of the event scheduling user. At step 32, the disclosed system operates to input a number of attendees for an event to be scheduled. The event attendees may be input at step 32 in any specific way, for example through a user interface screen defining which email destination address fields are to be used to contain email addresses corresponding to the event attendees, as further described below, or in some other specific manner.

At step 34, the disclosed system provides the event scheduling user with the option of prioritizing specific attendees with respect to other attendees, independent from designation of the specific destination address fields in which their corresponding email addresses are to be contained in an event notification email message. The option provided at step 34 may be provided through a user interface display object, such as a button, pull down menu, or the like, that can be activated by the event scheduling user clicking on it using a mouse or other pointing device.

At step 36, in response to user selection of the prioritization option provided at step 34, the disclosed system enables the event scheduling user to input attendee prioritizations. The specific number of priorities used by the event scheduling user at step 36 may be user specified, for example on an event specific basis, or defined as a user specific configuration parameter, or provided in some other appropriate way for a specific embodiment. The disclosed system enables the event scheduling user to indicate a specific priority for each attendee, and/or for groups of attendees as might be defined and associated with corresponding logical group names. The priorities defined at step 36 are independent from any associations of attendees with email destination address fields in an event notification email message subsequently generated to invite the attendees to the event being scheduled.

For example, an event scheduling user may consider the event attendees as falling into 5 categories, with priority 1 representing the most important attendees for the event, and priority 5 represent the least important. Accordingly, at step 36 the event scheduling user may assign specific attendees each with one of the priorities 1 through 5 at step 36. Since the priorities provided at step 36 are independent from the destination address fields for the event notification, the highest priority attendees (priority 1) could be included in any destination address field of the notification. This feature, for example, advantageously enables the event scheduling user to select an event time while ensuring that an attendee not included in the TO: field of the event notification is available for the event, and/or that some attendees addressed in the TO: field of the event notification are available for the event while other attendees addressed in that field may not be available, and/or that other specific attendee prioritizations indicated by the event scheduling user are considered.

In another embodiment, the disclosed system may operate to determine at step 36 whether all attendees have been assigned priorities by the event scheduling user through the event scheduling user interface. If not, then those attendees for which a priority has not been so assigned are automatically assigned a priority lower than any priority that was explicitly assigned to an attendee by the scheduling user through the event scheduling interface. For example, if the scheduling user assigns a highest priority (priority 1) to some subset of the attendees through the event scheduling user interface, and then indicates that they have no more priorities to assign, and/or that possible event times are to be calculated, then the disclosed system may be embodied to automatically assign a lower priority (priority 2) to the remaining attendees. Thus a next lower priority with respect to any lowest explicitly assigned priority may be automatically assigned to those attendees to which a priority was not explicitly assigned through the event scheduling interface, for purposes of calculating possible event times.

In the case where the scheduling user indicates that they have finished assigning priorities, but the set of priorities assigned to attendees does not include one or more higher order priorities with respect to a lowest assigned priority, the disclosed system may be embodied to indicate an error has occurred, and/or provide some number of possible event times based on the priorities that were assigned. For example, if a scheduling user were to only assign priorities 1 and 3 to some number of attendees, without assigning priority 2 to any assignees, the disclosed system may operate to convey a message or otherwise report a potential error, potentially in the same display that provides possible event times based on those priorities that were assigned, indicating that the scheduling user may have inadvertently forgotten to assign one or more users with the higher order priority, in this case priority 2.

Based on the attendees determined at step 32, and the priorities determined at step 36, and further responsive to user selection of the prioritization option provided at step 34, at step 38 the disclosed system operates to determine and present possible event times at which all attendees are available within each of the priorities obtained at step 36. The possible event times may then be presented to the event scheduling user in visually associated groups of times reflecting the complete availability of attendees within specific priorities. For example, a first set of possible event times may be presented at which all attendees at priority 1 are available. Another set of event times may be presented at which all attendees at priorities 1 and 2 are available, another set at which all attendees at priorities 1, 2 and 3 are available, and so on through the complete set of attendee priorities.

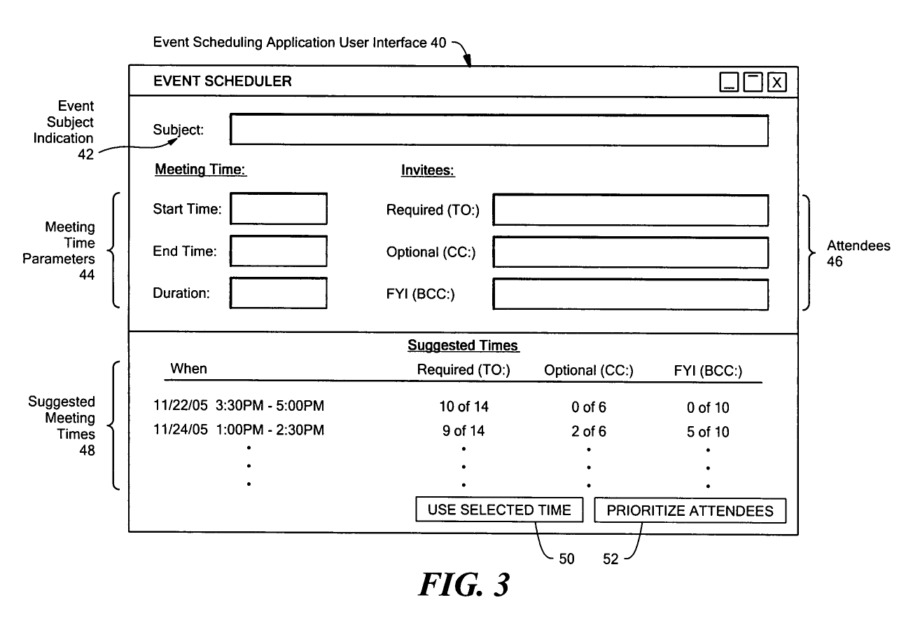

FIGS. 3-5 are simplified screen shots as provided through an embodiment of the event scheduling user interface 20 of FIG. 1. FIG. 3 shows an example of an event scheduling application user interface 40. An event subject indication field 42 allows the event scheduling user to enter a subject of the event being scheduled. Meeting time parameters fields 44 enable the event scheduling user to enter parameters regarding the event being scheduled, such as start time, end time, and duration. The attendees fields 46 enable the event scheduling user to enter names or email addresses associated with attendees for the event. In the example embodiment of FIG. 3, the event scheduling user is allowed to enter attendees into three initial categories: 1) Required (TO:), 2) Optional (CC:), and FYI (BCC:). Email addresses of attendees entered into the Required (TO:) category are included in the TO: field of the event notification for the event being scheduled, email addresses of attendees entered into the Optional (CC:) category are included in the CC: field of the event notification for the event being scheduled, and email addresses of attendees entered into the FYI (BCC:) category are included in the BCC: field of the event notification for the event being scheduled. The suggested meeting times 48 are determined by finding possible event times that most accommodate the schedule information for attendees in the Required (TO:) category, then the attendees in the Optional (CC:) category, and finally potentially also the attendees in the FYI (BCC:) category. Accordingly, the possible event times listed in order beginning with those that best match the schedule of the attendees in the Required (TO:) category, and so on.

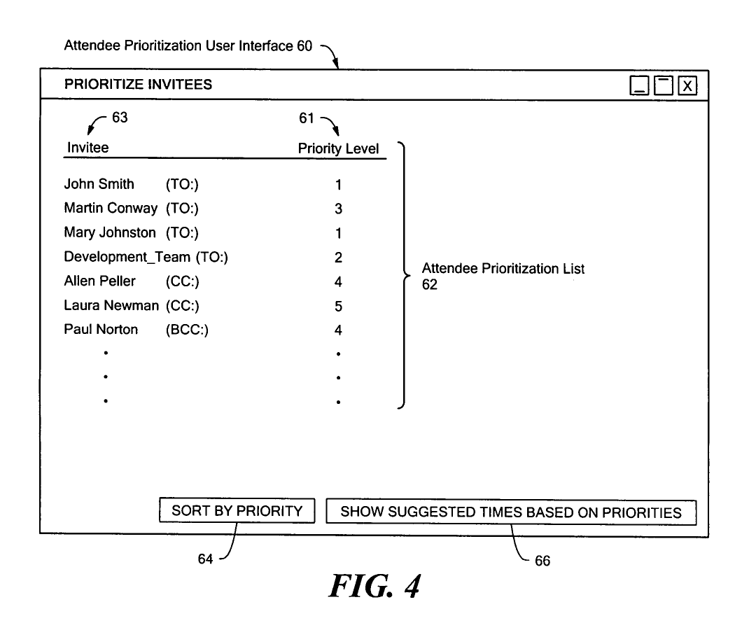

The event scheduling user is provided with a user interface display button 50 that can be clicked on with the mouse to request that a selected one of the possible meeting times within the suggested meeting times 48 is to be used to generate an event notification email message with destination email address fields populated with attendee email addresses as indicated by the Required (TO:), Optional (CC:) and FYI (BCC:) attendee categories. The event scheduling user is also provided with a user interface display button 52 that can be clicked on with the mouse to request that another interface screen or the like be provided in order to allow the event scheduling user to indicate attendee priorities to be associated with the event attendees or groups of attendees. An example of such a prioritization is shown by the attendee prioritization user interface 60 of FIG. 4.

As shown in FIG. 4, the attendee prioritization user interface 60 includes an attendee prioritization list 62 indicating a priority level associated with each attendee for the event being scheduled. The attendees can be assigned any priority in a user defined range of priorities, which may either be user-determined on an event specific basis, or may be user-configured for use across multiple events. For example, the disclosed system may be embodied to read in numeric priority levels entered into a priority level column 61 of the attendee prioritization list 62, where each numeric priority level indicates a relative attendee priority, with the highest level priority being priority 1, and higher numbers indicating progressively lower relative priority levels. Each row of the attendee prioritization list 62 further includes indication of an attendee or group of attendees within an invitee column 63. The attendees listed in the invitee column 63 may be represented by user names, email addresses, or other labels. Moreover, the information listed for each attendee in the invitee column 63 may further include an indication of which email destination address field that is to be used to store the email address for that attendee. In the example of FIG. 4, this information is provided for purposes of illustration within parenthesis following the user name of each attendee. The user may thus be automatically provided with a list of attendees in the invitee column 63, and then be allowed to enter numeric values indicating attendee priorities in the priority level column. It should be further noted that the attendee name in the invitee column 63 may indicate a predefined group of users, such as the “Development_Team” group name shown in FIG. 4. Such a group name would allow an event scheduling user to provide an attendee priority to be assigned to the entire attendee group. In one embodiment, the event scheduling user is further allowed to either assign attendee priority on a group basis to cover all group members, or alternatively provide different priorities to different group members. This permits a group name to be used to define the email destination address field to be used to store the email addresses of the group of the members of the group, and also allow the event scheduling user to independently indicate attendee priorities for individual group members.

A user interface display button 64 or the like is provided to allow the event scheduling user to cause the attendee prioritization list 62 to be re-ordered by priority level. A user interface display button 66 is provided to allow the event scheduling user to cause the disclosed system to provide a display of possible event times for the event being scheduled that reflect the attendee priorities defined through the attendee prioritization user interface 60.

Those skilled in the art will recognize that while the embodiment of the disclosed system shown in FIG. 4 includes a specific technique for entering and presenting attendee priorities, the present invention is not so limited. Accordingly, alternative embodiments may provide other specific interface designs or techniques allowing a scheduling user to provide attendee priorities for individual event attendees and/or groups of attendees. Similarly, those skilled in the art will recognize that attendee priorities need not be entered through a separate user interface screen than the user interface screen provided to allow the event scheduling user to define the email destination address fields to be used to store the email addresses of event attendees, and the same user interface screen may potentially be used for both purposes. Finally, the buttons 64 and 66 are only examples of user interface mechanisms that may be used to provide access to the associated functions, and various other specific techniques may be used for this purpose in the alternative.

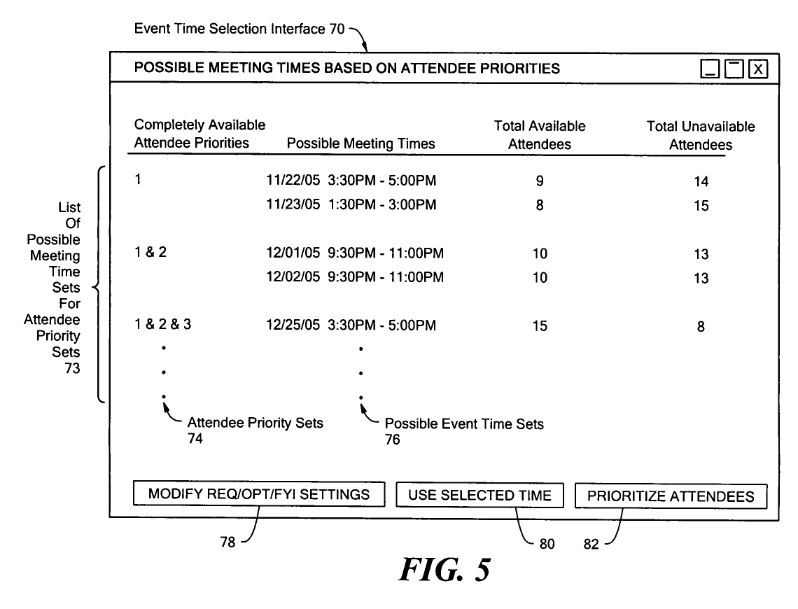

FIG. 5 shows an example of an event time selection interface 70 provided in response to an event scheduling user clicking on the user interface display button 66 shown in FIG. 4. As shown in FIG. 5, a list 73 of possible event time sets for attendee priority sets includes a number of rows, each row having a column 74 for the attendee priority sets corresponding to the possible event times in the column 76. In the embodiment of FIG. 5, the first row includes possible event times in column 76 at which all attendees having priority 1 are available. The second row includes possible event times in column 76 at which all attendees having priorities 1 or 2 are available. The third row includes possible event times at which all attendees having priorities 1, or 2, or 3 are available, and so on. The list 73 may further indicate the total numbers of attendees that are available and unavailable for each possible event time. The event scheduling user may then select one of the presented possible event times by clicking on it, and then click on the button 80 to use that selected time for the event being scheduled. Event notifications will be sent out using email having destination address fields populated with attendee email addresses as indicated in the user interface of FIG. 3. The event scheduling user may also choose to click on the button 78 to return to the user interface of FIG. 3 to modify the associations between attendees and email notification destination address fields, or click on the button 82 to return to the user interface of FIG. 4 to re-prioritize the attendees. In this way the disclosed system enables great convenience and flexibility to the event scheduling user to modify the attendee prioritizations independent from the associations between attendees and email notification destination address fields, resulting in quick access to a wider range of possible event times meeting the event requirements, and therefore more timely and effective event scheduling.

The disclosed system provides many significant advantages in various specific situations. For example, in a situation where the event scheduling user would like to set up a meeting with attendees A,B,C,D,E and F, and would further like Manager M and her administrative assistant N to attend. The event scheduling user may prefer to copy Manager M and her assistant on the event notification email message using the CC: destination address field, but also ensure that the meeting is scheduled for a time at which both M and N are available. The disclosed system enables this scheduling and notification to be conveniently performed.

Additionally, situations often arise where the success of a meeting may come down to the ability to aggregate groups of key attendees. For example, a meeting may have little value if either attendees (A AND B) OR (C AND D) cannot attend. The disclosed system enables associating priorities with attendees in a dynamic way that allows the event scheduling user to easily determine possible event times that satisfy such logical requirements between attendees, and to select the actual event time accordingly.

FIGS. 1 and 2 are block diagram and flowchart illustrations of methods, apparatus(s) and computer program products according to an embodiment of the invention. It will be understood that each block of FIGS. 1 and 2, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that they may be embodied using a variety of specific command structures.

I claim:

1. A method of scheduling an event in an event scheduling system, comprising:
determining a plurality of event attendees;
determining a plurality of attendee priorities;
presenting a user interface enabling a scheduling user to assign one of said attendee priorities to each of said event attendees;
determining a plurality of attendee priority sets;
determining a plurality of possible event time sets, wherein each of said possible event time sets corresponds to a respective one of said plurality of attendee priority sets, and wherein each of said possible event time sets contains only possible event times at which all of said event attendees assigned any attendee priority in said respective one of said plurality of attendee priority sets are available; and
presenting a user interface enabling said scheduling user to select one of said possible event times, wherein said user interface enabling said scheduling user to select one of said possible event times includes a visual correspondence between each of said plurality of possible event time sets and said corresponding one of said plurality of attendee priority sets.

2. The method of claim 1, wherein each of said plurality of priority sets includes one of said attendee priorities and all higher priorities.

3. The method of claim 2, further comprising:
determining a total number of said event attendees that are available for respective ones of said possible event times; and
displaying said total number of said available event attendees in visual correspondence with said respective ones of said possible event times.

4. The method of claim 3, further comprising:
determining a total number of said event attendees that are unavailable for respective ones of said possible event times; and
displaying said total number of said unavailable event attendees in visual correspondence with said respective ones of said possible event times.

5. The method of claim 4, further comprising presenting a user interface object enabling said scheduling user to prioritize said event attendees.

6. The method of claim 5, further comprising:
presenting a user interface enabling a user to categorize said event attendees into required and optional attendee categories;
presenting an initial set of possible event times reflecting said required and optional attendee categories; and
wherein said user interface object enabling said scheduling user to prioritize said event attendees is presented in combination with said initial set of possible event times, and wherein said attendee priorities are independent of said required and optional attendee categories.

7. The method of claim 6, wherein a total number of said attendee priorities is a user configurable parameter.

8. The method of claim 6, wherein a total number of said attendee priorities is an event specific parameter.

9. The method of claim 6, further comprising:
determining whether any of said event attendees have not been assigned one of said attendee priorities; and
in the event that at least one of said event attendees have not been assigned any one of said attendee priorities, assigning said event attendees that have not been assigned any one of said attendee priorities one of said attendee priorities lower than any of said attendee priorities that were previously assigned.

10. The method of claim 6, further comprising:
determining whether those of said attendee priorities that have been assigned to ones of said event attendees omits at least one of said attendee priorities of higher order than a lowest one of said attendees priorities that have been assigned to ones of said event attendees; and
in the event that those of said attendee priorities that have been assigned to ones of said event attendees omits at least one of said attendee priorities of higher order than a lowest one of said attendees priorities that have been assigned to ones of said event attendees, presenting an error message through said user interface enabling said scheduling user to select one of said possible event times.

11. A system having a computer readable medium, said computer readable medium having a computer program for scheduling an event in an event scheduling system stored thereon, said computer program comprising:
program code for determining a plurality of event attendees;
program code for determining a plurality of attendee priorities;
program code for presenting a user interface enabling a scheduling user to assign one of said attendee priorities to each of said event attendees;
program code for determining a plurality of attendee priority sets;
program code for determining a plurality of possible event time sets, wherein each of said possible event time sets corresponds to a respective one of said plurality of attendee priority sets, and wherein each of said possible event time sets contains only possible event times at which all of said event attendees assigned any attendee priority in said respective one of said plurality of attendee priority sets are available; and
program code for presenting a user interface enabling said scheduling user to select one of said possible event times, wherein said user interface enabling said scheduling user to select one of said possible event times includes a visual correspondence between each of said plurality of possible event time sets and said corresponding one of said plurality of attendee priority sets.

12. The system of claim 11, wherein each of said plurality of priority sets includes one of said attendee priorities and all higher priorities.

13. The system of claim 12, further comprising:
program code for determining a total number of said event attendees that are available for respective ones of said possible event times; and
program code for displaying said total number of said available event attendees in visual correspondence with said respective ones of said possible event times.

14. The system of claim 13, further comprising:
program code for determining a total number of said event attendees that are unavailable for respective ones of said possible event times; and
program code for displaying said total number of said unavailable event attendees in visual correspondence with said respective ones of said possible event times.

15. The system of claim 14, further comprising program code for presenting a user interface object enabling said scheduling user to prioritize said event attendees.

16. The system of claim 15, further comprising:
program code for presenting a user interface enabling a user to categorize said event attendees into required and optional attendee categories;
program code for presenting an initial set of possible event times reflecting said required and optional attendee categories; and
wherein said user interface object enabling said scheduling user to prioritize said event attendees is presented in combination with said initial set of possible event times, and wherein said attendee priorities are independent of said required and optional attendee categories.

17. The system of claim 16, wherein a total number of said attendee priorities is a user configurable parameter.

18. The system of claim 17, wherein a total number of said attendee priorities is an event specific parameter.

19. The system of claim 16, further comprising:
program code for determining whether any of said event attendees have not been assigned one of said attendee priorities; and
program code for, in the event that at least one of said event attendees have not been assigned any one of said attendee priorities, assigning said event attendees that have not been assigned any one of said attendee priorities one of said attendee priorities lower than any of said attendee priorities that were previously assigned.

20. The system of claim 16, further comprising:
program code for determining whether those of said attendee priorities that have been assigned to ones of said event attendees omits at least one of said attendee priorities of higher order than a lowest one of said attendees priorities that have been assigned to ones of said event attendees; and
program code for, in the event that those of said attendee priorities that have been assigned to ones of said event attendees omits at least one of said attendee priorities of higher order than a lowest one of said attendees priorities that have been assigned to ones of said event attendees, presenting an error message through said user interface enabling said scheduling user to select one of said possible event times.

21. A computer program product having a computer readable medium, said computer readable medium having a computer program for scheduling an event in an event scheduling system stored thereon, said computer program comprising:
program code for determining a plurality of event attendees;
program code for determining a plurality of attendee priorities;
program code for presenting a user interface enabling a scheduling user to assign one of said attendee priorities to each of said event attendees;
program code for determining a plurality of attendee priority sets;
program code for determining a plurality of possible event time sets, wherein each of said possible event time sets corresponds to a respective one of said plurality of attendee priority sets, and wherein each of said possible event time sets contains only possible event times at which all of said event attendees assigned any attendee priority in said respective one of said plurality of attendee priority sets are available; and
program code for presenting a user interface enabling said scheduling user to select one of said possible event times, wherein said user interface enabling said scheduling user to select one of said possible event times includes a visual correspondence between each of said plurality of possible event time sets and said corresponding one of said plurality of attendee priority sets.

22. A computer data signal embodied in a carrier wave, said computer data signal including at least one computer program for scheduling an event in an event scheduling system stored thereon, said computer program comprising:
program code for determining a plurality of event attendees;
program code for determining a plurality of attendee priorities;
program code for presenting a user interface enabling a scheduling user to assign one of said attendee priorities to each of said event attendees;
program code for determining a plurality of attendee priority sets;
program code for determining a plurality of possible event time sets, wherein each of said possible event time sets corresponds to a respective one of said plurality of attendee priority sets, and wherein each of said possible event time sets contains only possible event times at which all of said event attendees assigned any attendee priority in said respective one of said plurality of attendee priority sets are available; and
program code for presenting a user interface enabling said scheduling user to select one of said possible event times, wherein said user interface enabling said scheduling user to select one of said possible event times includes a visual correspondence between each of said plurality of possible event time sets and said corresponding one of said plurality of attendee priority sets.

23. A system for scheduling an event in an event scheduling system stored thereon, said computer program comprising:
means for determining a plurality of event attendees;
means for determining a plurality of attendee priorities;
means for presenting a user interface enabling a scheduling user to assign one of said attendee priorities to each of said event attendees;
means for determining a plurality of attendee priority sets;
means for determining a plurality of possible event time sets, wherein each of said possible event time sets corresponds to a respective one of said plurality of attendee priority sets, and wherein each of said possible event time sets contains only possible event times at which all of said event attendees assigned any attendee priority in said respective one of said plurality of attendee priority sets are available; and
means for presenting a user interface enabling said scheduling user to select one of said possible event times, wherein said user interface enabling said scheduling user to select one of said possible event times includes a visual correspondence between each of said plurality of possible event time sets and said corresponding one of said plurality of attendee priority sets.
